(19) United States
(12) Patent Application Publication
(10) Pub. No.: US 2008/0023415 A1
(43) Pub. Date: Jan. 31, 2008

(54) Motorcycle stand

(76) Inventor: Sivan Zuckerman, Saugus, CA (US)

Correspondence Address: Andra M. Vaccaro, 2953 Club Drive, Los Angeles, CA, 90064-4653, US

(21) Appl. No.: 11/495,250

(22) Filed: Jul. 28, 2006

(51) Int. Cl. A47F 7/00; B62H 7/00

(52) U.S. Cl. 211/20; 280/293

(57) ABSTRACT

A stand for supporting a motorcycle and the like at a convenient height so that the space between the wheels under the seat carriage are accessible for repair and servicing of otherwise hard to reach parts, having a cradle like support that supports the undercarriage. The stand includes a pair of upper arms fixedly spaced apart from each other at an angle that prevents the motorcycle from rolling off the stand and a pair of lower arms that can serve as a base for a work tray. The upper and lower arms are joined to vertical arms that allow unrestricted access to each side of the undercarriage. In addition, an optional side plate attachment may be affixed to the vertical arms for rider or motorcycle information and/or advertisement. Optional wheels may be used on the bottom of the rack to move it from place to place.

### FIELD OF THE INVENTION

This invention relates to devices for supporting motorcycles and the like during storage, repair and/or service procedures and particularly to a stand that supports a motorcycle in an elevated position that provides convenient access to the undercarriage of the motorcycle.

Unlike automobiles, much of the maintenance of a motorcycle is performed by the owner in a home garage, for instance. Due to the inaccessibility of the underside of the chassis of the motorcycle because of its close proximity to the floor, motorcycles generally are difficult to repair when they are inoperable or when their engines are off. Since the typical motorcycle periodically requires scheduled maintenance or repair operations, there needs to be a means to have easy access to its fittings and parts such as drain plugs which are located on the underside of the chassis.

Specifically, during maintenance procedures such as oil changes, the only way to access those parts located on the underside of the chassis is to either lay the motorcycle on its side or to kneel or lie down in an awkward and/or uncomfortable position next to the motorcycle. Since many motorcycles usually are being held in an inclined upright position by a collapsible kickstand, it is dangerous to try to reach underneath the chassis to access the part. Specifically, because, on most motorcycles, the kickstand is only secured at its upper end to a bracket which mounts to the underside of the motorcycle's chassis between the wheels, the substantial size and mass of the motorcycle result in the motorcycle being subject to tipping over particularly when an external force is applied thereto and thereby injuring the person performing the maintenance. Further, the kickstand is also often in the way. Thus, a kickstand is both an unreliable and dangerous means to maintain the motorcycle in an upright position.

With respect to racing motorcycles which typically have specialized stands which are positioned adjacent to one side of the rear wheel and which engages the wheel hub, the stands are also somewhat unstable since they, like kickstands, also support the motorcycle from only one side and typically do not permit the motorcycle to be maintained in a fully upright and stable position.

Thus, many different types of support devices have been invented to try to keep a motorcycle in an upright position while simultaneously raising it off the ground. For example, numerous motorcycle lifts have been disclosed in the prior art which elevate motorcycles off the floor to a level that is more convenient for accessing the underside of the chassis. These lifts are typically scissor-type jacks which are either mechanically, hydraulically or electrically actuated. Usually the jack is either rolled or slid under the chassis between the front and rear wheels such that when power is applied to the lift, the lift comes up under the center of the chassis, thereby elevating the motorcycle.

For example, U.S. Pat. No. 5,857,230 discloses a hammock and jack which lift the rear wheels. Due to the configuration that is disclosed, it does not provide the accessibility to the chassis provided by the stand of the present invention. Likewise, U.S. Pat. No. 5,639,067 also discloses a stand that includes a pivot-able rotating support surface that may be positioned beneath the frame of a motorcycle near either the front or rear wheel so that the wheel is lifted off the ground to provide access to the underside of the chassis. Due to the configuration that is disclosed, it does not provide the accessibility to the chassis provided by the stand of the present invention. U.S. Pat. No. 4,073,305 to Yamazaki further discloses a stand device for a motorcycle which tilts forward as the motorcycle remains stationary and rests against the stand and automatically moves the stand from its operative position to its neutral position when the motorcycle is brought to an upright position. Again, this stand does not provide the access to the chassis provided by the present invention.

Other devices involve lift mechanisms where one wheel of the motorcycle can be positioned on a part of the lift device which is then rotated so as to permit one wheel of the motorcycle to be lifted upwardly a small extent. These lift devices, intended principally for use when performing maintenance or service on the motorcycle, do not always provide the desired stability and, more specifically, are generally bulky and space-consuming.

Thus, while these and other prior art devices are successful in maintaining a motorcycle in an upright position, they still do not provide easy access to the undercarriage of the chassis. Usually the part of the lift that supports the motorcycle comes up under the chassis between the front and rear wheels thereby obstructing access to certain areas on the underside of the chassis such that it frequently interferes with the mechanic's job of dismantling some parts. While ramps were added to lifts to make it easier to place the motorcycle in the proper position on the lift, the ramp further interfered with complete access to certain parts that may be targeted for service or replacement. In addition, many of these lifts are cumbersome and expensive to produce and purchase.

### SUMMARY OF THE INVENTION

Therefore, it is an object of the present invention to provide a stand that supports an motorcycle in an elevated position so as to provide complete access to the motor and chassis between the wheels.

Another object of the present invention is to provide a stand for motorcycles and the like that is constructed to support motorcycles in a stable and elevated position so that the chassis can be accessed without the danger of the motorcycle tipping over.

Yet another object is to provide a stand for motorcycles and the like that conveniently may be moved to different locations.

A further object is to provide a stand for motorcycles and the like that provides a means for placing a placard on the front for either advertisement or identification purposes.

An additional object is to provide a stand for motorcycles and the like that has an area to place a tray.

A further object is to provide a stand for motorcycles and the like that is simple and easy to use.

A still further object is to provide a stand for motorcycles and the like that is economical to manufacture.

The present invention relates to a stand for engaging a wheel of a motorcycle or the like to enable the motorcycle to be safely and stably supported in a fully upright position. The support stand readily accommodates a wide range of different size motorcycles, is relatively small and can be positioned stably and securely on generally any flat surface. With the use of the optional coasters, the stand is portable, such that it can be moved from place to place.

In the preferred embodiment of the motorcycle stand of the present invention, the stand includes a pair of upper arms fixedly spaced apart from each other at an angle that prevents the motorcycle from rolling off the stand and a pair of lower arms that can serve as a base for a work tray. The upper and lower arms are joined to vertical arms that allow unrestricted access to each side of the undercarriage. In addition, an optional side plate attachment may be affixed to the vertical arms for rider or motorcycle information and/or advertisement. Optional wheels may be used on the bottom of the rack to move it from place to place. In the preferred embodiment of the present invention, the arms of the stand are made of metal. In an alternate embodiment, the stand may be made of sturdy plastic able to sustain the weight of the motorcycle without collapsing.

### BRIEF DESCRIPTION OF THE DRAWINGS

FIG. 1 is a perspective view of the front, left and top of the preferred embodiment of the present invention showing a motorcycle thereon in phantom.

FIG. 2 is a perspective view of the front, left, and top of the preferred embodiment of the present invention shown in FIG. 1.

FIG. 3 is a perspective view of the rear, left, and top of the preferred embodiment of the present invention shown in FIG. 1.

FIG. 4 is a top plan view of the preferred embodiment of the present invention shown in FIG. 1.

FIG. 5 is a perspective view of the front, left, and top of an alternative embodiment of the present invention shown in FIG. 4.

FIG. 6 is a perspective view of the rear, left, and top of the alternative embodiment of the present invention shown in FIG. 4.

FIG. 7 is a top plan view of the alternative embodiment of the present invention shown in FIG. 4.

### DETAILED DESCRIPTION

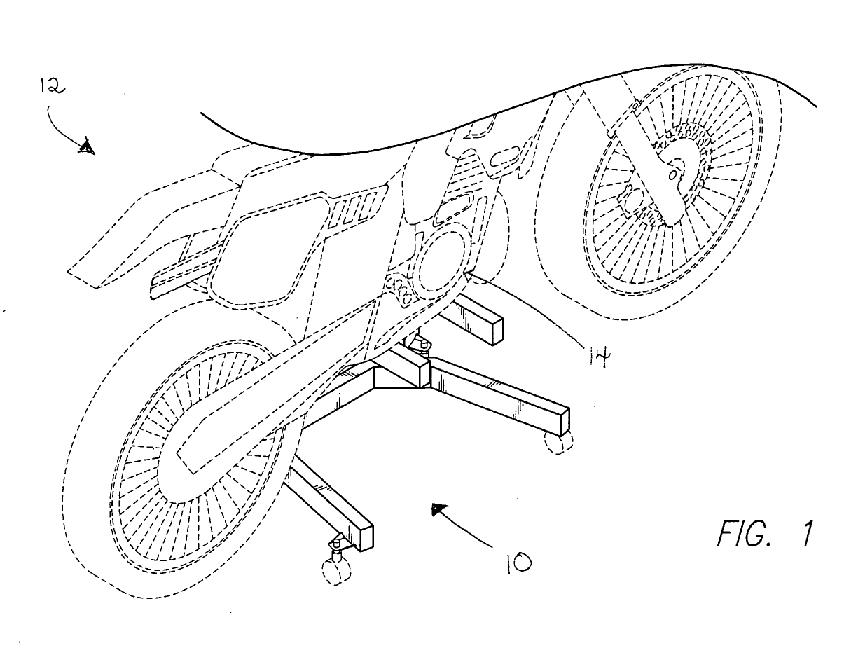

Referring to FIG. 1, there is illustrated the preferred embodiment of a motorcycle support stand 10 according to the present invention onto which a motorcycle 12 is shown supported thereon in phantom. The stand 10 is intended for cooperation with the chassis 14 of a conventional two-wheel motorcycle 12 so as to maintain the motorcycle 12 in a stationary and stable upright position without requiring utilization of any other supporting structures such as a kickstand or other device.

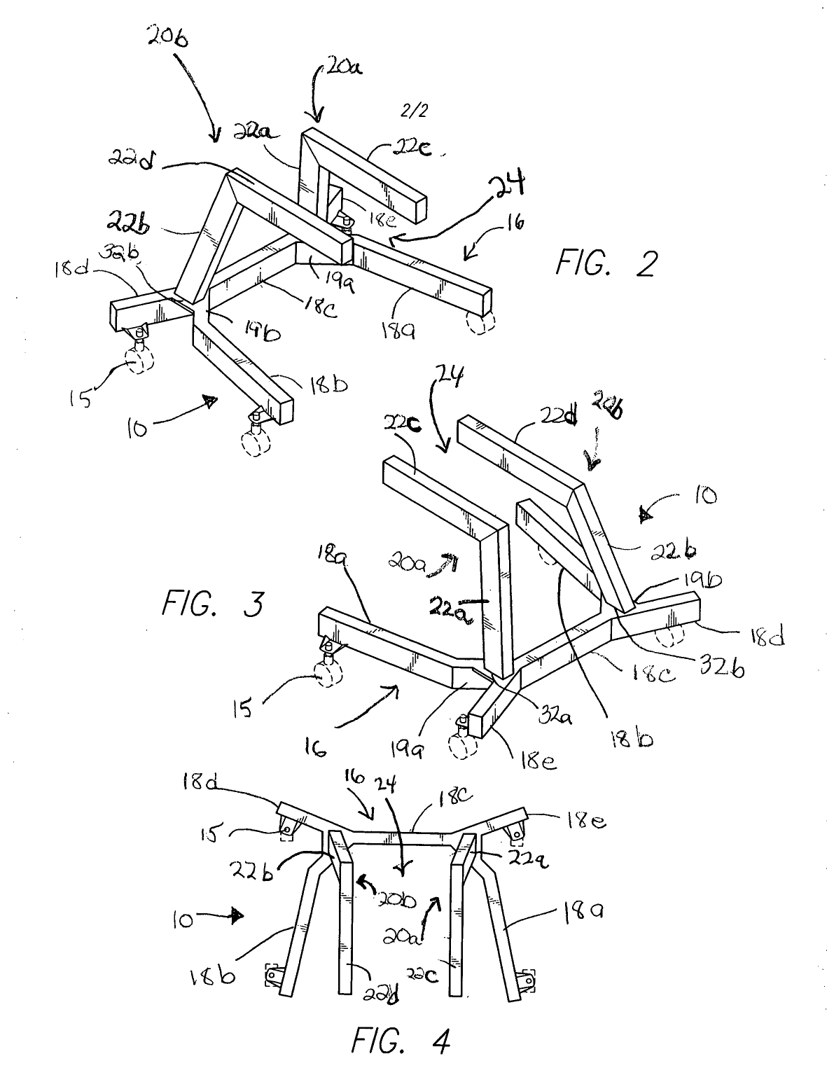

As illustrated in FIGS. 2-7, the stand 10 includes a horizontal polygonally shaped base 16 which is intended to either be placed directly on a generally flat horizontal support surface such as a floor or the ground or mounted onto coasters 15 so that the stand 10 can be moved from place to place on the floor or ground. Coasters 15 may have a locking mechanism so as to prevent the stand from moving. Alternatively, the stand 10 can be fixed to the floor by providing the leg parts of the base with suitable fasteners such as bolts or the like projecting through openings in the leg parts for engagement with the supporting floor.

The base member 16 has a main center part 1 8c disposed between and generally horizontally coextensive with a pair of wing parts 18a and 18b which extend outwardly from opposite ends of the main center part 18c. The two wing parts 18a and 18b are substantially identical to one another except for being mirror images.

In the preferred embodiment, wing parts 18a and 18b are joined to the respective ends of main center part 18c via parts 19a and 19b, respectively. 18c. Arms 18d and 18e likewise extend respectively from each end of bar 18c so as to create mirrored obtuse angles with arms 19a and 19b respectively. In the preferred embodiment, there is an approximately 145° angle between arms 18a and 19a; an approximately 135° angle between arms 19a and 18c; an approximately 100° angle between arms 18a and 18c and an approximately 160° angle between arms 18e and 18c. Looking at the plan view shown in FIG. 4, the main center part 18c is substantially lesser in width than the gap created by wings 18a and 18b at the opposite ends thereof.

Mounted on base 16 are two cantilevered upright angular arms 20a and 20b which are comprised of a pair of spaced apart angular upright arms 22a and 22b which project upwardly from the base 16 proximate each end of bar 18c. Specifically, upright arms 22a and 22b are rearwardly sloped relative to the horizontal plane of base 16. In the illustrated and preferred embodiment, the areas at which arms 22a and 22b are attached to base 16 comprise generally triangular cross-sectional elements 32a and 32b, respectively.

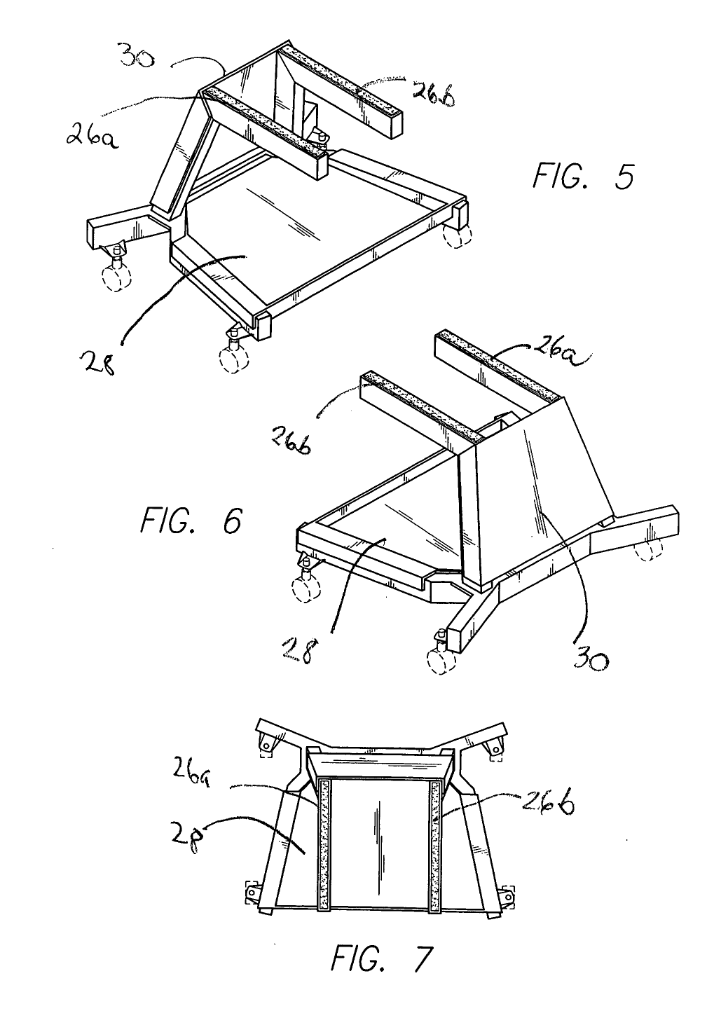

Affixed to the upper ends of upright arms 22a and 22b are mounting arms 22c and 22d, respectively, which essentially are affixed in an approximately parallel relationship to each other so as to define a chassis-accommodating gap or space 24 therebetween which can accommodate the chassis of a wide range of different types of motorcycles. Thus, when a motorcycle is mounted onto the stand 10, the chassis is supported by arms 22c and 22d. In the alternate embodiment shown in FIGS. 5-7, mounted on the upper surface of arms 22c and 22d are friction strips 26a and 22b, respectively. The friction strips 26a and 26b create positive retention of the chassis within the stand in view of the additional frictional contact created by strips 26a and 26b. In the preferred and alternate embodiments, the two upright arms 20a and 20b are substantially identical to one another except for being mirror images.

Thus, due to the design of the cantilevered arms 20a and 20b affixed atop of the relatively larger base 16, the stand has the necessary strength and stability to prevent tipping of the motorcycle when mounted thereon. Specifically, as shown in FIG. 1, when a motorcycle is mounted on the stand 10 such that the chassis is supported by arms 22c and 22d, it is maintained in a stable upright position such that a person can access the underside of the chassis without fear that the motorcycle will lean or tilt over.

In addition, in the alternate embodiment shown in FIGS. 5-7, a tray 28 is mounted on wings 18a and 18b. The tray is especially useful during maintenance procedures to store tools and needed parts. Additional, an optional faceplate 30 may be mounted across upright angular arms 22a and 22b. The faceplate can be used as a sign to provide information about the particular motorcycle mounted on the stand 10.

In the alternate embodiment, the tray 28 is a large and horizontally-extending platelike member which, for simplicity and efficiency of construction, is preferably a flat metal plate, although it can be fabricated of plastic or any other structurally reinforced material.

In a further embodiment of the present invention, arms 22c and 22d may also include a pair of retainers (not shown) which are fixed to and project upwardly from the upper surface of arms 22c and 22d. The retainers extend in generally parallel relationship and are spaced apart in the front-to-back direction of the support stand so as to be disposed generally equal distances on opposite sides so as to hold the chassis in place. Specifically, the spacing between each pair of retainers provides supportive engagement with the outer sides of the motorcycle chassis when it is placed upon arms 22c ands 22d of the support stand 10 to provide stable support of the motorcycle.

In the illustrated and preferred embodiment, the areas at which arms 22a and 22b are attached to base 16 comprise generally triangular cross-sectional elements 32a and 32b, respectively.

During fabrication of the stand 10, the arms are welded together and is simple in construction, inexpensive to make, and effective in supporting a motorcycle in a stable position. In the preferred embodiment, the arms and wings are formed from metal, although any structurally strong material may be used. The resulting structure when assembled is strong and durable, and yet relatively small such that it can be readily transported or moved about if desired. When in use, the stand does not require fixed securement to the floor since The stand 10 is initially used by rolling the motorcycle so that its chassis straddles the gap that is created by arms 22c and 22d and rests on arms 22c and 22d to provide sufficient support and access to the underside of the chassis.

While the stand 10 as described above and as illustrated in the accompanying drawings represents a preferred construction, it will nevertheless be recognized that the shape of the stand or of parts thereof, and the construction thereof with respect to details of the various parts, can be modified without departing from the essential structural and functional relationships thereof which are apparent from the above description and drawings. Specifically, while particular embodiments and techniques of the present invention have been shown and illustrated herein, it will be understood that many changes, substitutions and modifications may be made by those persons skilled in the art. It will be appreciated from the above description of the presently preferred embodiment that other configurations are possible and within the scope of the present invention. Thus, the present invention is not intended to be limited to the particular embodiments as specifically discussed hereinabove.

What is claimed is:

1. A stand for a motorcycle having a chassis, comprising:
a base comprising a main center portion disposed between and generally horizontally coextensive with a pair of wing portions which extend outwardly from opposite ends of said main center portion to stabilize said base; and
two cantilevered spaced apart arms mounted on and projecting upwardly and rearwardly from said base proximate the main center portion; said cantilevered arms having horizontal upper portions thereof which extend over the gap created by said wing portions of said base and on which the chassis of a motorcycle may be mounted.

2. The stand of claim 1, wherein said wing portions are substantially identical and mirror images of each other.

3. The stand of claim 1, wherein said base further comprises a pair of arms corresponding with said wing portions, each of said arms extending between said main center portion to its corresponding wing portion so as to create mirrored obtuse angles between said main center portion and said corresponding wing portion, so as to further stabilize the base and cause the gap between said wing portions to be greater in width than said main center portion.

4. The stand of claim 1, wherein said upper portions of said cantilevered arms further comprise friction strips mounted on the upper surface thereof.

5. The stand of claim 1 further comprising a tray that spans the gap between said wing portions and said main center portion.

6. The stand of claim 1 further comprising a faceplate which may be mounted across said upright angular arms.

7. A stand for a motorcycle having a chassis, comprising:
a base comprising a main horizontal center portion disposed between, and generally horizontally coextensive with, a pair of wing portions which extend outwardly from opposite ends of said main center portion to stabilize said base, wherein the outer ends of said wings are disposed farther apart than the inner ends of said wings;
two cantilevered spaced apart substantially angular arms mounted on and projecting upwardly and rearwardly from said base proximate the main center portion having horizontal upper portions in a substantially parallel relationship so as to define a chassis-accommodating gap which can accommodate and support the chassis of a wide range of different types of motorcycles in an upright position; and
means for moving said stand mounted on said base.

8. The stand of claim 7, wherein said wing portions comprise a pair of outer arms and a pair of inner arms, said inner arms extending between said main center portion and its corresponding outer arm, wherein said inner arm creates mirrored obtuse angles between said main center portion and said corresponding outer arm so as to further stabilize the base and cause the gap between said wing portions to be greater in width than the width of said main center portion.

10. The stand of claim 7, wherein upper portions of said cantilevered arms comprise friction strips mounted on the upper surface thereof.

11. The stand of claim 7 further comprising a tray that spans the gap between said wing portions and said main center portion.

12. The stand of claim 7 further comprising a faceplate which may be mounted across said upright angular arms.
